(19) United States
(12) Patent Application Publication
(10) Pub. No.: US 2015/0309980 A1
(43) Pub. Date: Oct. 29, 2015

(54) A FRAMEWORK FOR ENABLING USER-DEFINED FUNCTIONS

(71) Applicant: ARIADNE INSIGHT LIMITED, West Malling (GB)

(72) Inventors: Jonathan GLASS, West Malling (GB); Darren HARRIS, West Malling (GB)

(21) Appl. No.: 14/650,829

(22) PCT Filed: Dec. 11, 2013
(86) PCT No.: PCT/GB2013/000544

§ 371 Date: Jun. 9, 2015

(30) Foreign Application Priority Data
Dec. 11, 2012 (GB) 1222279.0

(51) Int. Cl. G06F 17/24

(52) U.S. Cl. CPC G06F 17/246

(57) ABSTRACT

A computer program product for use in conjunction with a spreadsheet application program comprises a framework having a library of defined functions. The spreadsheet application is, in use, executed in a first process in memory on a computer and the function is, in use, held in a second process, which second process is independent of the first process. The or each user defined function is adapted to be called from a cell in the spreadsheet application, the function being evaluated or executed in the second process to return a value which is shown in the cell. This reduces the memory footprint of the application and results in a more stable computer system.

The invention relates to a framework for enabling user-defined functions for use in conjunction with spreadsheet application software.

In many environments, users have limited or no programming skills and only have access to and an ability to use productivity software, an example of which is Microsoft Office. Typically users will use the spreadsheet application, eg Microsoft Excel, for data analysis.

Commonly, spreadsheets are created to support ad-hoc or periodic analysis and reporting tasks, by users who are proficient analysts and have a good understanding of the data they are analysing, but are not specialist programmers. Ideally, a spreadsheet given new input data should automatically update the required reports and analysis.

Spreadsheets enable users to analyse a complex system over a two-dimensional (one worksheet) or three-dimensional (multiple worksheets) space. When a user wishes to analyse multiple similar complex systems, there are several strategies available—making multiple copies of the workbook, making multiple copies of the worksheet(s) within the workbook, translating the analysis into a single row so it can be tabulated, or translating the analysis into a programming language such as VBA and exposing it back to the spreadsheet as a user-defined function. All these approaches result in either unmanageable numbers of workbooks or worksheets that are time consuming to maintain and error prone, and/or a loss of structure of the analysis during the translation process which makes it much harder to understand how it works. Translating the analysis to a programming language would require specialist programming skills.

Spreadsheets are furthermore often shared among several analysts, grow in size and complexity and eventually become a burden to support, maintain and enhance because of their size and complexity. This can lead to errors, slow time to insight/slow reporting cycles, manual keying/copying of data. Also there are inherent size limitations given the file size and complexity, number of formula calculations etc meaning that sheets become slower and more unstable as they grow, and with that become prone to corruption and loss of data. Where business processes which are supported by complex spreadsheet become critically important (for regulatory or other reasons), it is often very difficult to prove that the spreadsheet operates reliably.

Organisations which identify that they have a problem with large and hard-to manage spreadsheets, often attempt to migrate from spreadsheets to a purpose-built IT system. This migration can be extremely expensive and time consuming, because of the need to replicate all the business logic embodied within the spreadsheets in a new system, which involves extensive analysis of requirements and effectively re-keying all of the logic within the spreadsheet into code within the system. Once this has been done, it also becomes much harder to update or improve the system, or to investigate and fix problems, than it was using a spreadsheet. As the migration process itself, if successful, can commonly take several months or longer to complete, a further common problem is that the business logic in the spreadsheet itself will have developed in the intervening period so that the new purpose built IT system no longer reflects the current business requirements.

Spreadsheet applications typically provide a mechanism by which the set of functions provided for use within cell formulas can be augmented with ‘addins’ which implement additional user-defined functions (commonly known as ‘UDFs’) which are then made available to use in cell formulas in the same way as the application's built-in functions. Since UDFs execute within a cell formula, they may only return a value which can be represented within a cell, for example a single piece of text or a single number. This limits the usefulness of UDFs where it would be better to return a more complex result.

Another common problem encountered with the more complex spreadsheets is that repeated re-calculation of the spreadsheet causes a continually increasing memory footprint. This in turn leads to stability problems, and is particularly common where UDFs are used. The memory of the computer system is used to store the data inputs to the spreadsheet calculation process, the inputs and results of any intermediate calculations and the final results of the calculation process. Since it is in the nature of a spreadsheet that all these values are available to view within the spreadsheet application, they must all be retained, meaning that a significant amount of memory is required with more complex spreadsheets.

Furthermore a recent trend in computing has been the growth of the volumes of data being captured, processed and stored, and where spreadsheets are used to analyse data, this has led to a similar increase the amount of memory required to calculate a spreadsheet. While a spreadsheet program is running, the spreadsheets being used may be re-calculated a number of times. Each time this happens, the intermediate calculations and results are all repeated, which leads to further memory being consumed by these new results. Eventually the program becomes unstable, as it will be unable to allocate further memory to store the results of later calculations. The lack of memory then leads to a crash either of the application or of the computer system.

Additionally it is common for the spreadsheet to run in a 32 bit process even on 64 bit systems as this ensures better compatibility with other existing applications such as add-ins and external data providers. As 32 bit processes can only address up to 4GB of system memory, the spreadsheet application may become a source of instability due to a high percentage of this memory being allocated to the spreadsheet.

The present invention therefore seeks to provide a computer program product for use in conjunction with a spreadsheet that addresses these problems.

According to a first aspect of the invention there is provided a computer program product for use in conjunction with a spreadsheet application program comprising a framework having a library of functions, which functions comprise one or more defined functions, wherein the spreadsheet application is, in use, executed in a first process in memory and the function is, in use, held in a second process, which second process is independent of the first process, wherein the or each user defined function is adapted to be called from a cell in the spreadsheet application, the function being evaluated or executed in the second process to return a value which is shown in the cell

According to a second aspect of the invention there is provided a computer program product for use in conjunction with a spreadsheet application program comprising a framework having a library of functions, which functions comprise one or more defined functions, such that when the user defined function has been evaluated or executed and returns a structured value or object which cannot be represented within a single cell, allocates a unique identifier value which is shown in the cell, the value being returned being a symbolic code.

The invention therefore provides a new type of function supported by a framework, which function executes out of process and may return a structured result which is stored out-of-process. Hereinafter, this is referred to as a Structured Result Function (SRF). The result object is a structured result (SR) returned by an SRF, which is too complex to represent in a single spreadsheet cell, and instead is passed back to the spreadsheet as a unique pointer value. By providing a framework for registering ‘Structured Result UDFs’ (‘SRFs) within the spreadsheet application, advantageously allowing that the result of an SRF call need not be able to be represented in a single cell within the spreadsheet application, and where this is the case, passing back to the spreadsheet an encoded value representing the structured result of the call, which encoded value can be represented within a single cell, and used as a proxy to that structured result, for example to use it as an argument in a subsequent SRF call. Advantageously, the execution of the SRFs is hosted in a process outside the spreadsheet process, therefore it is possible to use SRFs which consume large amounts of memory either in execution or in storing their results, without increasing the memory footprint of the spreadsheet process, thereby enhancing reliability and stability in the spreadsheet.

Advantageously the memory allocated to objects which are result of SRF evaluation is not held within the same process as the spreadsheet. This means that the total memory used by the spreadsheet process is reduced leading to better stability and allowing more and larger spreadsheets and other addins to be opened at the same time. Where the spreadsheet package becomes unstable at a certain memory threshold (which is less than the maximum memory available from the operating system to a process), structured result size is not constrained by this limit. Moreover, where a user has a 64 bit operating system but a 32 bit version of the spreadsheet package, object size is not constrained by the 32 bit memory limit.

In a preferred embodiment, structured results can be visualised in a manner which does not depend on rendering them into a grid of cells as the structured result is held within the framework process, and without needing to use further SRF calls to pull simple values out of the structured result.

Preferably, the system advantageously provides the ability to create a function object (hereinafter referred to as dynamic user defined function or ‘DDF’) as the result of an SRF call, defined from the formulae within a range-of cells in the spreadsheet, which can be called in a similar way to a UDF, but is defined purely from the contents of a spreadsheet, without the need to do any programming in the traditional sense.

In a preferred embodiment the system implements the DDF as dynamically compiled, strongly typed code, which may be dynamically re-compiled based on both the type and value of each argument, each time a previously unseen combination is encountered in a call to the DDF.

Preferably, the system is advantageously able to save DDFs in such a way that they can be integrated with existing computer systems, providing an alternative way to implement complex business logic without needing to write code. This integration is bi-directional, in that the DDFs saved in this way can also be used to reconstruct the original spreadsheet.

From the perspective of the spreadsheet program, the invention enables large intermediate calculation results to be stored in the spreadsheet process as a single, short piece of text, which requires little memory compared to the entire data set, which is stored in a separate process. Therefore, the program can achieve many more repeated cycles of calculation without the risk of memory usage becoming excessive and causing a crash. Even if the process of the invention were to crash, the spreadsheet application would remain stable and no user data would be lost.

In addition, where the computer system has a 64 bit operating system, but the spreadsheet application is run in a 32 bit process, the process of the invention may still be run as a 64 bit process. Since many modern computers have more than 4GB of system memory, which is the most that can be addressed by a 32 bit process, the process in this case could allocate more memory than the spreadsheet program would be able to. The invention therefore results in a more stable computer.

Exemplary embodiments of the invention will now be described in greater detail by reference to the following example:

Spreadsheet packages such as Microsoft Excel provide a means for non-programmers to use formulas to combine and manipulate data, as well as present the resulting analysis through formatting, tables, charts etc.

Spreadsheets can be configured to calculate automatically or in response a user input, but in both cases the engine underlying the spreadsheet understands that cell formulas which reference another cell will be affected whenever that input cell changes. Accordingly, updates to input cells can provoke a set of updating calculations in their dependent cells, and so on, automatically updating output reports etc with a minimum number of incremental calculations.

Where a large amount of data needs to be analysed in a consistent manner to produce a results, spreadsheets allow tables of input data to be extended by ‘copying down’ a formula in a new column, to produce a column of calculated figures, each of which depends on the input values in its corresponding row. Formulas can also look up values from associated data sets and calculate summary information.

The spreadsheet package will provide a library of functions which can be used within cell formulas to cover most users' needs. Also, the package provides ways in which user-defined functions can be created to provide specialist functionality, for example a specialist statistical function.

The system of the invention provides a framework comprising a library of functions, which integrate with an existing spreadsheet engine by registering additional functions within the spreadsheet environment. The system further comprises means for hosting evaluation or execution of the functions outside the spreadsheet process, and a means of viewing and otherwise interacting with the results of evaluating or executing SRFs, outside of the spreadsheet environment The framework comprises add-ins, which are programs that the spreadsheet can load when its starts up. The add-in contains the code that provides additional functionality and in particular user defined functions. The SRFs are hosted in a process outside the spreadsheet program but registered within the spreadsheet process. The evaluation or execution takes place outside the spreadsheet process. In use, the SRF may return a structured result which cannot be represented within a single cell in the spreadsheet, in which case the framework stores this result and allocates it a unique pointer value. The SRFs are registered as functions in the spreadsheet process, and so can be called in the same way as any other function in the spreadsheet. When one of these UDFs is called, the spreadsheet process passes the argument values and/or pointers to a separate process in which the SRF is executed, and the resulting value or unique pointer value is passed back to the spreadsheet process to be displayed or used for further calculation in the cell hosting the call to the function.

The framework provides a library of functions to interpret a range of cells in the spreadsheet as a dynamically defined function (DDF), encapsulating the logic of any formulas contained therein. The DDF can then be called independently and repeatedly elsewhere, with differing input values to consistently calculate a result using the same logic.

The unique pointer value is a symbolic code for a result value which could not otherwise be represented in a single cell. So, for example, if an SRF were to return a table of data with 10 columns and 10,000 rows, it would be impossible to return that into a single cell in Excel with a traditional UDF. By encoding the return value as a symbol, a pointer to the resource is passed back to the spreadsheet without needing to pass all the data back to the spreadsheet. Although the encoded result is a meaningless piece of text as far as the spreadsheet is concerned, it can still be used as an argument for a subsequent call to another a framework UDF, at which point the framework is able to decode the pointer back to the original table of data.

The framework therefore allows a user to work with argument and result values for SRFs which could not otherwise be accommodated by the spreadsheet (which can only represent single numeric or text values in a single cell), while still retaining the ability to pass the result of one formula cell as the input to another formula, which is a key differentiating feature of Excel, for example.

A key existing feature of a spreadsheet application is the ability to enter a formula into a cell, which will calculate a result based on the values of other cells, which are referenced by the formula. Formulas in one cell may depend on the result of formulas in other cells, creating a ‘dependency tree’ where the value of a cell may depend on many input cells, via numerous intermediate cell formulas. The system of the invention provides a means to interpret such a dependency tree of cell formulas by means of an SRF into a dynamically defined function, which is stored by the framework as a structured result. By supplying arguments to the SRF defining the range of cells within which the dependency tree exists, the cells within that range which are inputs, and the cells within that range which are outputs, and by parsing the functions and operators, and their arguments, from within cell formulas, the system is able to construct an executable code function which will replicate the behaviour of the dependency tree range of cells, meaning that if certain input values were passed to the function, and the same values were inserted into the input cells defined within the range, then the outputs from executing the code function would be the same as the values that would be seen in the output cells of the range once the spreadsheet was calculated.

By dynamically translating the logic embedded within a set of user-entered formulas, into an executable module of code, and by representing that module as a structured result passed back as a pointer into a cell within the spreadsheet, it becomes possible to re-use business logic which has been implemented by a user within a spreadsheet, without the need to copy and paste it once for every time it is required. This DDF can be invoked directly from within the sheet by passing it to subsequent SRF functions, however unlike a regular UDF, since the definition of the DDF is carried out as part of the normal recalculation process of the spreadsheet, any changes not just to input value when the DDF is used, but also any changes to the formulas in the range of cells which define the DDF, will be reflected in the function whenever the sheet is calculated.

For example, if the formula “=A1+10” is used as part of the definition of a DDF, defining the output, with cell A1 defined as the input, then re-using the resulting function with an input of 20 would return an output of 30 (the input value plus ten). If the input were changed to 30 then the output would change to 40. Equally, if the cell formula in the definition were changed to “=A1−10” and the input left as 20, the output would change to 10.

By supporting this behaviour, the system of the invention enables complex and fully-featured business logic to be created and maintained in one single place, by users with no familiarity with writing code, only a familiarity with the use of formulas within a spreadsheet package. Dynamically defined functions created in this way can be re-used consistently and reliably without the need to copy and paste sections of the spreadsheet, and any later modifications to the formulas need only be made and checked in a single place, providing improved reliability.

When the framework allocates an object to a cell, it indexes the allocated object according to the name of the function called and the values of the arguments passed. Whenever a subsequent call is made (in that cell or another), and if the SRF and arguments are already present in the index, and if the function is not explicitly declared as volatile, the result value can be returned immediately, without the need to re-evaluate the function call.

Since a spreadsheet may be calculated and then re-calculated many times, and given that each call to one of the framework functions causes a result object to be created and allocated into memory, it is not sustainable to keep recalculating a spreadsheet without having some means of freeing up memory allocated to SRF result object which are no longer required. The invention includes novel techniques for enabling this.

Where the framework is made aware of the cell from which a SRF call originates, the framework will consider the object, which is the result of that call to be allocated to that cell. Whenever a subsequent call allocates a new object to the cell, the framework can release objects previously allocated to that cell. Once an object has been released, its memory can be re-used, however it is no longer available to be the input to a call.

In a further embodiment, where the framework allocates an object to a cell, it will only release previously allocated objects when it receives a call from a different cell. This is in order to support cases where a nested formula includes two different UDF results which have been calculated within the formula, as arguments to a subsequent function also within that formula. For example, where f( ) and g( ) are both framework functions, a formula of the form =f(g(x), g(y)) would be supported, since neither the result of g(x) nor the result of g(y) would have been released before the call to f( )

In another further embodiment, where the framework allocates an object to a cell, it will only release previously allocated objects when it receives a call which takes the pointer assigned to that object as one of its arguments. This is in order to support the possibility that the spreadsheet engine may partially calculate a formula before moving on to calculate another cell. In the example of =f(g(x), g(y)), if g(x) and g(y) were first calculated, then another cell, then returning to calculate the outer f( ), the results of g(x) and g(y) will not have been released.

Structured values are only visible as their pointer values within the spreadsheet cells.

The framework provides a viewer window, either as a separate window or dockable within the spreadsheet application, which allows the object represented by the selected pointer to be visualised in a manner appropriate to the object type. The view may be static or interactive. Objects of particular interest may be pinned to new windows or tabs, in order to be viewable even when the cell is not selected.

The framework registers the SRFs automatically with the spreadsheet engine, but when a SRF is called, the argument values are passed to a separate process for evaluation, then the resulting value or pointer is passed back to the originating process. Objects allocated to the pointer are held within the separate process, only the pointer value is passed back to the spreadsheet engine.

Users tend to enter values into a spreadsheet without providing any clue as to their data type. For example if a user enters “10” in a cell, then although it is a piece of text, the user would expect =“10”+“1” to return 11. A key challenge in being able to turn the formulas within ranges of cells into executable code is being able to cope with the complexity of this dynamic typing without sacrificing performance or memory consumption.

When the framework resolves a call, for example through overload resolution (determining which of a set of functions registered against a single function name is most appropriate) and by converting the arguments to the data types required by the function, the framework compiles the results of this logic into native code, and indexes it by the function name and the argument types. When the function is subsequently called with the same argument types, the framework refers the call to the compiled code, significantly reducing the time required to make the call.

In a further embodiment, where conditions based on the argument values affect the overload resolution, only the conditions satisfied by the call are compiled into native code. Where a subsequent call does not satisfy the conditions in the compiled code, the call is passed back to the framework which evaluates the new set of conditions and compiles both sets of logic into native code, replacing the original compiled logic. This is repeated every time the call to a function satisfies previously unseen conditions.

Where a spreadsheet embodies a piece of business logic by transforming a set of input data and control or configuration parameters in order to produce output data, reports etc, and where this is implemented by built-in formulas, framework UDFs or a combination of the two, the framework enables the extraction of this logic directly into a module of computer source code, or into a configuration document such as an XML file. This source code may then be compiled and integrated along with the framework libraries within a server-based computer system to reliably implement the same business logic as in the spreadsheet.

Where a module of computer source code, or a configuration document such as an XML file has been integrated by the framework from a spreadsheet into a server-based computer system, and whenever any problems are observed with its operation, or changes need to be made to the business logic embodied within that module, the source code or configuration document is decorated with additional information in such a way as to enable the framework to recreate a spreadsheet which allows input data and control or configuration parameters to be injected, and outputs produced to reliably implement the same business logic as in the spreadsheet.

Where a complex calculation needs to be carried out repeatedly, it need only be defined in one place and can then be used wherever required. This reduces the need to implement custom functions in support of particular needs, since any calculation which can be built up from a series of calls to existing functions, can be created as an expression and then used in much the same way as a UDF.

Where a function call is made repeatedly with the same arguments, the time taken to call the function is dramatically improved with the second and subsequent calls. This is beneficial whenever a value changes (or a volatile function recalculates) in an open spreadsheet. Although the spreadsheet engine may support incremental recalculation, where modifying a cell causes only those cells dependant on the modified cell to be recalculated, whenever recalculation of a dependent cell does not cause that cell's value to change, the spreadsheet engine may still recalculate all dependants of that cell, which must therefore have the same argument values as the last time they were evaluated. A secondary benefit of this approach is that where the same formula is repeated within a sheet, or where two different formulas happen to call the same function with the same argument values, the function need only be evaluated once.

Where a function call is made repeatedly with the same argument types, and where the argument values satisfy the same call conditions, the time taken to call the functions is dramatically improved with the second and subsequent calls. This is beneficial whenever a function is called repeatedly with different argument values, such as when evaluating the function for every row of a table.

Since, preferably, only the code necessary to evaluate the function given the argument values used is compiled, the compilation time is reduced when first calling the function, and the size of the compiled function is kept to a minimum.

When a spreadsheet embodies a critical business process which needs to be incorporated into a system, this allows the business logic to be reliably captured from the spreadsheet without the need for extensive business analysis and re-coding as functionality within a spreadsheet is sufficient for the framework to automatically generate the equivalent executable module. The migration of functionality is likely therefore to be faster and less error-prone, as well as requiring less extensive testing and being easier to subsequently update if the spreadsheet were to change.

When a system whose critical business logic was originally implemented within a spreadsheet needs to be inspected due to any suspected issues or the need to change or enhance the business logic, this can be done within the familiar environment of the spreadsheet rather than needing to modify computer source code or a configuration document, and without the need to retain (and verify the equivalence of) the spreadsheet from which the module was originally generated. Any changes can be saved as modifications to the generated module of source code or configuration document and, depending on the characteristics of the system, it may be possible to immediately modify the behaviour of the system without the need to rebuild and redeploy.

1. A computer program product for use in conjunction with a spreadsheet application program comprising a framework having a library of functions, which functions comprise one or more defined functions, wherein the spreadsheet application is, in use, executed in a first process in memory and the function is, in use, held in a second process, which second process is independent of the first process, wherein the or each user defined function is adapted to be called from a cell in the spreadsheet application, the function being evaluated or executed in the second process to return a value which is shown in the cell.

2. A computer program product for use in conjunction with a spreadsheet application program comprising a framework having a library of functions, which functions comprise one or more defined functions, such that when the user defined function has been evaluated or executed and returns a structured value or object which cannot be represented within a single cell, allocates a unique identifier value which is shown in the cell, the value being returned being a symbolic code.

3. A computer program product for use in conjunction with a spreadsheet application program comprising a framework having a library of functions, which functions comprise one or more defined functions, wherein the spreadsheet application is, in use, executed in a first process in memory and the function is, in use, held in a second process, which second process is independent of the first process, wherein the or each function is adapted to be called from a cell in the spreadsheet application, the function being evaluated or executed in the second process to return a value which is shown in the cell, the framework allocating a unique identifier value which is shown in the cell, the value being returned being a symbolic code.

4. The computer program product according to claim 1, wherein if the unique identifier is passed as an argument to another defined function held outside the first process, the framework ensures that the corresponding object is passed to the function.

5. The computer program product according to claim 1, wherein, the framework is adapted to release objects previously allocated to the cell so that once an object has been released, its memory can be re-used.

6. The computer program product according to claim 1, wherein structured values can be visualised in a manner which does not depend on rendering the values into a grid of cells as the structure value is held within the framework process, such that the computer program product does not need to use further calls to pull simple values out of the object.

7. The computer program product according to claim 1, wherein the computer program product dynamically re-compiles code based on both the type and value of each argument, each time a previously unseen combination of type and value is encountered.

8. The computer program product according to claim 1, wherein by parsing the functions and operators, and their arguments, from within cell formulas, the computer program product is able to construct an executable code function which will replicate the behaviour of the range of cells, so that if certain input values were passed to the function, and the same values were inserted into the input cells defined within the range, then the outputs from executing the code function would be the same as the values that would be seen in the output cells of the range once the spreadsheet was calculated.

9. The computer program product according to claim 2, wherein if the unique identifier is passed as an argument to another defined function held outside the first process, the framework ensures that the corresponding object is passed to the function.

10. The computer program product according to claim 2, wherein, the framework is adapted to release objects previously allocated to the cell so that once an object has been released, its memory can be re-used.

11. The computer program product according to claim 2, wherein structured values can be visualised in a manner which does not depend on rendering the values into a grid of cells as the structure value is held within the framework process, such that the computer program product does not need to use further calls to pull simple values out of the object.

12. The computer program product according to claim 2, wherein the computer program product dynamically re-compiles code based on both the type and value of each argument, each time a previously unseen combination of type and value is encountered.

13. The computer program product according to claim 2, wherein by parsing the functions and operators, and their arguments, from within cell formulas, the computer program product is able to construct an executable code function which will replicate the behaviour of the range of cells, so that if certain input values were passed to the function, and the same values were inserted into the input cells defined within the range, then the outputs from executing the code function would be the same as the values that would be seen in the output cells of the range once the spreadsheet was calculated.

14. The computer program product according to claim 3, wherein if the unique identifier is passed as an argument to another defined function held outside the first process, the framework ensures that the corresponding object is passed to the function.

15. The computer program product according to claim 3, wherein, the framework is adapted to release objects previously allocated to the cell so that once an object has been released, its memory can be re-used.

16. The computer program product according to claim 3, wherein structured values can be visualised in a manner which does not depend on rendering the values into a grid of cells as the structure value is held within the framework process, such that the computer program product does not need to use further calls to pull simple values out of the object.

17. The computer program product according to claim 3, wherein the computer program product dynamically re-compiles code based on both the type and value of each argument, each time a previously unseen combination of type and value is encountered.

18. The computer program product according to claim 3, wherein by parsing the functions and operators, and their arguments, from within cell formulas, the computer program product is able to construct an executable code function which will replicate the behaviour of the range of cells, so that if certain input values were passed to the function, and the same values were inserted into the input cells defined within the range, then the outputs from executing the code function would be the same as the values that would be seen in the output cells of the range once the spreadsheet was calculated.
